(19) United States
(12) Patent Application Publication
(10) Pub. No.: US 2025/0235794 A1
(43) Pub. Date: Jul. 24, 2025

(54) AUTOMATED COMPUTATION OF PARAMETERS FOR CONFIGURATION OF A GAME ENGINE

(71) Applicant: Playtika LTD, Herzeliya (IL)

(72) Inventors: Andrey LISOVOY, Tel Aviv (IL); Yotam ROTHOLZ, Ramat HaSharon (IL); Aharon Zvi SHIFF, RaAnana (IL)

(73) Assignee: Playtika LTD, Herzeliya (IL)

(21) Appl. No.: 19/034,704

(22) Filed: Jan. 23, 2025

Related U.S. Application Data
(60) Provisional application No. 63/623,862, filed on Jan. 23, 2024.

(51) Int. Cl. A63F 13/79

(52) U.S. Cl. CPC A63F 13/79

(57) ABSTRACT

There is provided a method of automatically configuring a gaming engine, comprising: accessing, a user achievement requirement denoting goals and/or milestones for a player to accomplish within a game, the user requirement comprising associated factors defining measurement of meeting the user achievement requirement by the player, predicting a target set of configuration parameters that when used for configuring the gaming engine, result in the player meeting the user achievement requirement as measured by the associated factors, wherein the target set of configuration parameters comprises a combination of a first and a second type of configuration parameters, the first type being associated with setting an effort level predicted to be tolerated by the player, and the second type associated with setting a reward level predicted as an incentive by the player, and providing the target set of configuration parameters for configuring the gaming engine.

### RELATED APPLICATION(S)

This application claims the benefit of priority under 35 USC § 119 (e) of U.S. Provisional Patent Application No. 63/623,862 filed on Jan. 23, 2024, the contents of which are incorporated by reference as if fully set forth herein in their entirety.

### FIELD AND BACKGROUND OF THE INVENTION

The present invention, in some embodiments thereof, relates to game engines and, more specifically, but not exclusively, to system and methods for automated configuration of a game engine.

The configuration of a game engine involves setting various parameters and options to tailor the engine's behavior, appearance, and performance according to the specific requirements of a game project. Configurations can encompass a wide range of settings, from graphics and audio options to input controls and networking parameters.

### SUMMARY OF THE INVENTION

According to a first aspect, computer implemented method of automatically configuring a gaming engine to conform with a user achievement requirement for a player playing a game, comprises: accessing, the user achievement requirement denoting goals and/or milestones for the player to accomplish within the game, the user requirement comprising a plurality of associated factors defining measurement of meeting the user achievement requirement by the player, predicting a target set of configuration parameters that when used for configuring the gaming engine, result in the player meeting the user achievement requirement as measured by the associated factors, wherein the target set of configuration parameters comprises a combination of a first type of configuration parameters and a second type of configuration parameters, the first type of configuration parameters being associated with setting an effort level predicted to be tolerated by the player, and the second type of configuration parameters associated with setting a reward level predicted as an incentive by the player, and providing the target set of configuration parameters for configuring the gaming engine predicted to result in the player meeting the user achievement requirement as measured by the plurality of associated factors.

According to a second aspect, a system for automatically configuring a gaming engine to conform with a user achievement requirement for a player playing a game, comprises: at least one processor executing a code for: accessing, the user achievement requirement denoting goals and/or milestones for the player to accomplish within the game, the user requirement comprising a plurality of associated factors defining measurement of meeting the user achievement requirement by the player, predicting a target set of configuration parameters that when used for configuring the gaming engine, result in the player meeting the user achievement requirement as measured by the associated factors, wherein the target set of configuration parameters comprises a combination of a first type of configuration parameters and a second type of configuration parameters, the first type of configuration parameters being associated with setting an effort level predicted to be tolerated by the player, and the second type of configuration parameters associated with setting a reward level predicted as an incentive by the player, and providing the target set of configuration parameters for configuring the gaming engine predicted to result in the player meeting the user achievement requirement as measured by the plurality of associated factors.

According to a third aspect, a non-transitory medium storing program instructions for automatically configuring a gaming engine to conform with a user achievement requirement for a player playing a game, which when executed by at least one processor, cause the at least one processor to: access, the user achievement requirement denoting goals and/or milestones for the player to accomplish within the game, the user requirement comprising a plurality of associated factors defining measurement of meeting the user achievement requirement by the player, predict a target set of configuration parameters that when used for configuring the gaming engine, result in the player meeting the user achievement requirement as measured by the associated factors, wherein the target set of configuration parameters comprises a combination of a first type of configuration parameters and a second type of configuration parameters, the first type of configuration parameters being associated with setting an effort level predicted to be tolerated by the player, and the second type of configuration parameters associated with setting a reward level predicted as an incentive by the player, and provide the target set of configuration parameters for configuring the gaming engine predicted to result in the player meeting the user achievement requirement as measured by the plurality of associated factors.

In a further implementation form of the first, second, and third aspects, the user achievement requirement includes a progression rate requirement defining a rate at which the player needs to advance through the game to achieve a target objective.

In a further implementation form of the first, second, and third aspects, the user achievement requirement includes a return-to-player requirement defining a gain that the player is predicted to receive while playing the game.

In a further implementation form of the first, second, and third aspects, the associated factors defining measurement of meeting the return-to-player requirement comprises at least one of: (i) a parameter describing a financial gain of the player resulting from playing in conjunction with the gaming engine and as expressed using an in-game token and/or expressed using another class of assets associated with the gaming engine, and (ii) a parameter describing a social gain of the player resulting from playing in conjunction with the gaming engine.

In a further implementation form of the first, second, and third aspects, the target set of configuration parameters comprises a target balance between the first type and the second type of configuration parameters.

In a further implementation form of the first, second, and third aspects, further comprising: determining, prior to the predicting of the target set of configuration parameters, a set of candidate configuration parameters comprising a candidate balance between the first type of configuration parameters and the second type of configuration parameters, wherein the candidate balance is predicted to meet the user achievement requirement, analyzing the candidate set of configuration parameters by a simulation engine and/or a machine learning (ML) model, determining according to the analysis that the second type of configuration parameters associated with setting the reward level predicted as an incentive by the player, defines a reward that is too high for the gaming engine to sustain, in response to determining that the second type defines a reward that is too high, iterating the determining the candidate set, and the analyzing until the second type is determined according to the analysis to define the reward sustainable by the gaming engine, and providing the set of candidate configuration parameters as the target set of configuration parameters comprising the target balance between the first type and the second type of configuration parameters.

In a further implementation form of the first, second, and third aspects, further comprising: determining, prior to the determining of the target set of configuration parameters, a set of candidate configuration parameters comprising a candidate balance between the first type of configuration parameters and the second type of configuration parameters, wherein the candidate balance is predicted to meet the user achievement requirement, and analyzing the candidate set of configuration parameters by a simulation engine and/or outcome of a ML model, determining according to the analysis that the first type of configuration parameters associated with setting the effort level predicted to be tolerated by the player, defines an effort level that is too high for the players to tolerate, and in response to determining that the first type defines the effort level that is too high for the players to tolerate, iterating the determining the candidate set, and the analyzing until the first type is determined according to the analysis to define the effort level that the players tolerate, and providing the set of candidate configuration parameters as the target set of configuration parameters comprising the target balance between the first type and the second type of configuration parameters.

In a further implementation form of the first, second, and third aspects, the predicting comprises: predicting, by a prediction engine, an effect of an initial set of candidate configuration parameters on the user achievement requirement when the initial set of candidate configuration parameters is to be used for configuring the gaming engine, and sending the predicted effect to a configuration engine, adjusting, based on the predicted effect, by the configuration engine, the initial set of candidate configuration parameters to generate a next set of candidate configuration parameters that when used for configuring the gaming engine, is predicted to result in increased likelihood of the player meeting the user achievement requirement in comparison to using the initial set of candidate configuration parameters to configure the gaming engine, and providing, by the configuration engine to the prediction engine, the next set of candidate configuration parameters for generating another prediction of the effect of the next set of candidate configuration parameters on the user achievement requirement.

In a further implementation form of the first, second, and third aspects, further comprising: in a plurality of iterations: implementing the predicting, the adjusting, and the providing, by setting the initial set of a subsequent iteration according to the next set of the preceding iteration, and terminating the iterations when the next set of candidate configuration parameters used for configuring the gaming engine results in the player meeting the user achievement requirement, and candidate configuration parameters of the preceding iteration as the target set of configuration parameters.

In a further implementation form of the first, second, and third aspects, the prediction engine is includes a ML model trained to predict an effect of an input set of configuration parameters on the user achievement requirement, wherein the ML model is trained on a training dataset of a plurality of records, wherein a record includes a sample set of configuration parameters including the combination of the first type of configuration parameters and the second type of configuration parameters, and a ground truth indicating a sample effect of the sample set of configuration parameters including the combination of the first type of configuration parameters and the second type of configuration parameters on the user achievement requirement.

In a further implementation form of the first, second, and third aspects, the prediction engine includes a simulation engine for simulating implementation of an input set of configuration parameters on playing of the game for predicting the effect on the user achievement requirement.

In a further implementation form of the first, second, and third aspects, the simulation engine simulates actions of real players playing the game configured with the input set of configuration parameters.

In a further implementation form of the first, second, and third aspects, the simulated actions of real players is attained using a ML model trained to mimic real player behavior by learning historical interactions of real players with the game engine configured with one or more a sample sets of configuration parameters.

In a further implementation form of the first, second, and third aspects, at least one of the plurality of associated factors includes an indication of a progression rate that players are experiencing while trying to go through a certain level of the game executed by the gaming engine.

In a further implementation form of the first, second, and third aspects, the progression rate comprises at least one of: (i) a parameter describing a probability of the player passing the certain level on the first try, (ii) an average time for the player to pass the certain level, and (iii) the percentage of players that are unable to pass the certain level without a clue and/or another aid.

In a further implementation form of the first, second, and third aspects, at least one of the first type of configuration parameters of the target set of configuration parameters, associated with the effort level comprises an indication of increasing a difficulty of going through the certain level.

In a further implementation form of the first, second, and third aspects, the first type of configuration parameters associated with increasing the difficulty of going through the certain level, comprises at least one of: (i) a parameter indicating a number of negative events and/or sprites are encountered by players trying to pass the certain level, (ii) a parameter indicating a level of availability of different aids to players trying to pass the certain level, and (iii) a parameter describing graphical settings and/or user interface settings expected to influence player performance while trying to pass the certain level.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for computing a target set of configuration parameters for configuring a game engine to conform with a user achievement requirement for a player playing a game, in accordance with some embodiments of the present invention;

FIG. 2 is a flowchart of a method of computing a target set of configuration parameters for configuring a game engine to conform with a user achievement requirement for a player playing a game, in accordance with some embodiments of the present invention;

FIG. 3 is a flowchart of an exemplary method for computing the target set of configuration parameters, in accordance with some embodiments of the present invention; and

FIG. 4 is another exemplary method for computing the target set of configuration parameters, in accordance with some embodiments of the present invention.

### DESCRIPTION OF SPECIFIC EMBODIMENTS OF THE INVENTION

The present invention, in some embodiments thereof, relates to game engines and, more specifically, but not exclusively, to system and methods for automated configuration of a game engine.

As used herein, the terms game engine and gaming engine are interchangeable.

As used herein, the terms configuration of a game, and configuration of the gaming engine that runs the game are interchangeable. Features described herein with respect for automatically configuring the gaming engine that runs the game may be applied for automatically configuring the game.

An aspect of some embodiments of the present invention relates to systems, methods, computing devices, and/or code instructions (stored on a data storage device and executable by one or more processors) for automatically configuring a gaming engine to conform with a user achievement requirement for a player playing a game run by the gaming engine. The user achievement requirement is accessed. The user achievement requirement denotes goals and/or milestones for the player to accomplish within the game, for example, a progression rate requirement defining a rate at which the player needs to advance through the game to achieve a target objective, and/or a return-to-player requirement defining a gain that the player is predicted to receive while playing the game. The user requirement includes one or more associated factors defining measurement of meeting the user achievement requirement by the player. A target set of configuration parameters is computed. The target set of configuration parameters is predicted to result in the player meeting the user achievement requirement as measured by the associated factors (while playing the game run by the gaming engine). The target set of configuration parameters includes a combination of a first type of configuration parameters and a second type of configuration parameters. The first type of configuration parameters are associated with setting an effort level predicted to be tolerated by the player. The second type of configuration parameters are associated with setting a reward level predicted as an incentive by the player. The target set of configuration parameters is provided for configuring the gaming engine, predicted to result in the player meeting the user achievement requirement as measured by the associated factors.

At least some implementations described herein address the technical problem of configuring a game engine. In particular, the technical problem relates to configuring the game engine for reaching a defined user achievement requirement. At least some implementations described herein improve the technical field of game engines, by providing approaches for configuration of the game engine for reaching a defined user achievement requirement. At least some implementations described herein improve over prior approaches of configuration of game engines, for example, manual trial and error approaches in which different parameters are tweaked by an administrator with domain knowledge.

Configuring a game engine to achieve a defined user achievement requirement can be a complex task, and various challenges may arise during the process. In particular, there may be a large number of adjustable parameters whose values impact the player reaching goals and/or milestones within the game as defined by the user achievement requirement. Moreover, predicting human player response to the gaming engine with different combinations of adjustable parameters is challenging.

The configuration parameters of a game engine that can impact user achievement requirements are diverse and can vary depending on the specific features and capabilities of the game engine. The technical problem of adjusting the configuration parameters to reach the defined user achievement requirement is particularly challenging due to the large number of possible combinations of configuration parameters. Moreover, different combinations of configuration parameters may have synergistic effects, for example, positively amplifying each other, negatively amplifying each other, or cancelling each other out. As such, selecting the values of combination of configuration parameters to reach the user achievement requirement is difficult to perform for individual configuration parameters. The values for the configuration parameters are to be selected for the combination of configuration parameters as a set.

Inventors discovered that a balance between the first type of configuration parameters associated with setting an effort level predicted to be tolerated by the player and the second type of configuration parameters associated with setting a reward level predicted as an incentive by the player is highly significant for reaching the user achievement requirement. The first type of configuration parameters and the second type of configuration parameters are tightly correlated with one another, such that setting a value of one of the configuration parameters impacts the other configuration parameter. However, the first and second types of configuration parameters may differ in what they impact. The first type related to effort may impact how hard the player actually needs to play, such as play skills, concentration, and physical exertion. The second type related to reward may impact the motivation of the player. Inventors discovered that the first and second types of configuration parameters are to be set as a combination, i.e., together, rather that independently determining each type of configuration parameter. The first type and second type of configuration parameters achieve a synergistic effect, which may be positive in terms of reaching the user achievement requirement when correctly set, or may be negative in terms of not reaching the user achievement requirement such as by cancelling each other out when incorrectly set. For example, a high reward (i.e., the second type) motivates a player to improve their skills to put in more effort (i.e., the first type). On the flip side, a player may encountering a difficult game which requires more effort may be discouraged from playing if the reward is too low. The synergistic effect obtained when a balance between the first type and second type is reached is a surprising point or region that is technically difficult to determine since it cannot be simply computed using scalar based approaches. For example, the reward can be greatly reduced when a right difficulty level is determined.

An example is now described for a game where the player controls a character that needs to overcome obstacles to reach an end point. The user achievement requirement may be for the player to complete level 2 within a range of 4-5 minutes. The associated factors may be the current level of the player, and elapsed time. The first type of configuration parameters may include a number of obstacles that may be encountered in level 2. The second type of configuration parameters may include a number of coins that can be collected in level 2. Examples of possible synergistic effects of the first and second type include: too many obstacles and too may coins may lead to the player taking too long to reach the end, or the player may become discouraged and stop playing. Few obstacles and few coins may lead to the player completing the level too quickly, or the player may stop playing since game is too easy and/or not rewarding. Many obstacles and few coins which are hard to obtain may lead to a player taking too long to reach the end point without being sufficiently rewarded, leading the player losing interest. Few obstacles and many coins which are easy to obtain may lead to the player taking too long to each the end point and being greatly rewarded but without a feeling of satisfaction arising from overcoming challenges.

At least some embodiments described herein provide a solution for the aforementioned technical problem, and/or improve the aforementioned technical field, and/or improve upon the aforementioned prior approaches, by predicting a combination of the first type and second type of configuration parameters, that when used to configure the game engine, result in the player meeting the user achievement requirement.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

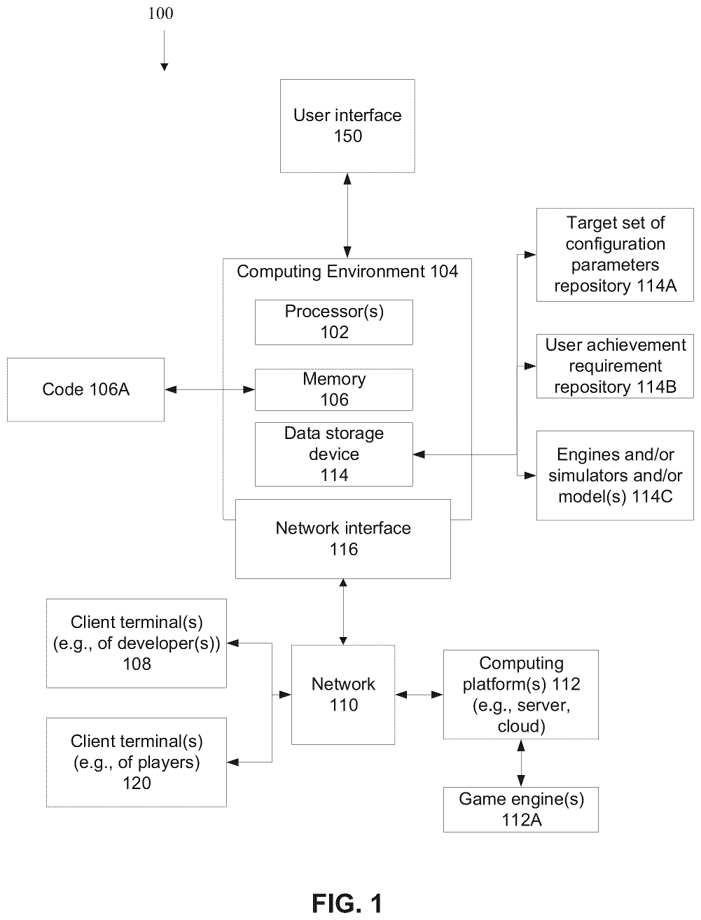

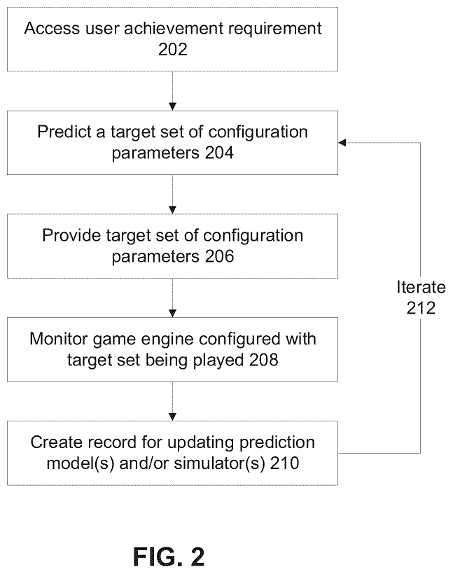

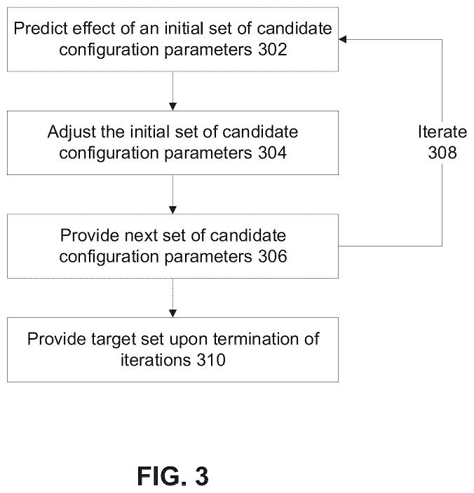

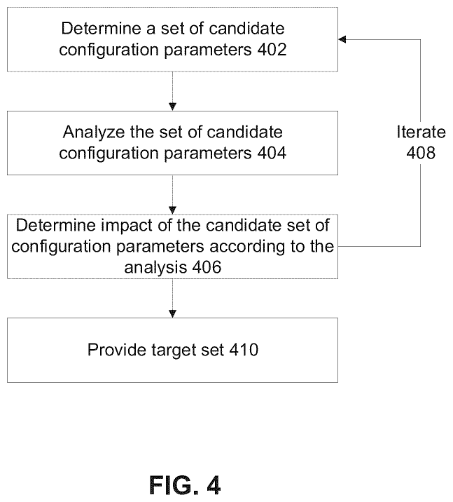

Reference is now made to FIG. 1, which is a block diagram of components of a system for computing a target set of configuration parameters for configuring a game engine to conform with a user achievement requirement for a player playing a game, in accordance with some embodiments of the present invention. Reference is also made to FIG. 2, which is a flowchart of a method of computing a target set of configuration parameters for configuring a game engine to conform with a user achievement requirement for a player playing a game, in accordance with some embodiments of the present invention. Reference is also made to FIG. 3, which is a flowchart of an exemplary method for computing the target set of configuration parameters, in accordance with some embodiments of the present invention. Reference is also made to FIG. 4, which is another exemplary method for computing the target set of configuration parameters, in accordance with some embodiments of the present invention.

System 100 may implement the acts of the method described with reference to FIGS. 2-4 by processor(s) 102 of a computing environment 104 executing code instructions 106A stored in a memory 106 (also referred to as a program store).

Computing environment 104 may be implemented as, for example one or more and/or combination of: a computing cloud, a group of connected devices, a server, a virtual server, a client terminal, a virtual machine, a desktop computer, a thin client, a network node, and/or a mobile device (e.g., a Smartphone, a Tablet computer, a laptop computer, a wearable computer, glasses computer, and a watch computer).

Computing environment 104 may predict a target set of configuration parameters (e.g., stored in repository 114A) that include a combination of a first type and a second type, as described herein. Computing environment 104 may provide the target set of configuration parameters 114A for configuring a game engine 112A.

Game engine 112A configured according to the target set of configuration parameters (e.g., from repository 114A) may be hosted by a computing platform 112, for example, a server and/or computing cloud. Game engine 112 may be designed for interaction by a single player or multiple players (e.g., simultaneously), optionally using respective client terminals 120 via a network 110.

Multiple architectures of system 100 based on computing device 104 may be implemented. For example:
Computing environment 104 may be separate from computing platform 112. In such architecture, computing environment 104 computes the target set of configuration parameters, and provides the target set of configuration parameters to computing platform 112 for configuration of game engine 112A.
Computing environment 104 may be integrated with computing platform 122. In such architecture, the configuration of game engine 112A using the target set of configuration parameters may be done by computing environment 104 (i.e., the integrated platform).
Computing environment 104 may centrally compute the target set of configuration parameters for different games run by the same game engine 112A and/or by different game engines 112, on the same computing platform 112 and/or on different computing platforms 112. Respective computed target sets of configuration parameters are provided for configuring respective game engines 112A optionally on respective computing platforms 112. Different client terminals 108 may access computing environment 104 for instructing computation of different target sets of configuration parameters, for example, providing respective user achievement requirements (e.g., provided by respective client terminals 108).
Computing environment 104 may be locally running on a dedicated device, for example, a mobile device and/or client terminal of a user. For example, a user uses their own computing environment 104 to compute a personalized target set of configuration parameters for customizing game engine 112A. The customized game engine 112A may be run remotely on computing platform 112 (which is separate from computing environment 104) or locally run on computing platform 112 integrated with computing environment 104.
Configuration of game engine 112A using the target set of configuration parameters may be performed, for example, manually by a user (e.g., via client terminal 118), automatically by computing platform 112, automatically by computing environment 104 (e.g., remotely accessing game engine 112A, such as via a virtual interface for example, an application programming interface (API)), and/or by another external computing device.

Computing environment 104 may provide the service of computing the target set of configuration parameters in response to input of a user achievement requirement, for example by: providing software as a service (SaaS) to the client terminal(s) 108, providing software services accessible using a software interface (e.g., application programming interface (API), software development kit (SDK)), providing an application for local download to the client terminal(s) 108, providing an add-on to a web browser running on client terminal(s) 108, and/or providing functions using a remote access session to the client terminals 108, such as through a web browser executed by client terminal 108 accessing a web site hosted by environment device 104 such as remote access of computing environment 104.

Processor(s) 102 of computing environment 104 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions executable by processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method described with reference to FIGS. 2-4 when executed by processor(s) 102.

Computing environment 104 may include a data storage device 114 for storing data, for example, target set of configuration parameters repository 114A set to store the computed target sets of configuration parameters, user achievement requirement repository 114B set to store the user achievement requirements, and engines and/or simulators and/or models 114C as described herein. Data storage device 114 may be implemented as, for example, a memory, a local hard-drive, virtual storage, a removable storage unit, an optical disk, a storage device, and/or as a remote server and/or computing cloud (e.g., accessed using a network connection). It is noted that code stored on data storage device 114 may be loaded into memory 106 for execution by processor(s) 102.

Exemplary architectures of ML model(s) and/or engines and/or simulator 114C described herein include neural networks of various architectures (e.g., convolutional, fully connected, deep, encoder-decoder, recurrent, transformer, graph), support vector machines (SVM), logistic regression, k-nearest neighbor, decision trees, boosting, random forest, a regressor, and/or any other commercial or open source package allowing regression, classification, dimensional reduction, supervised, unsupervised, semi-supervised, and/or reinforcement learning. Machine learning models may be trained using supervised approaches and/or unsupervised approaches.

Network 110 may be implemented as, for example, the internet, a local area network, a virtual network, a wireless network, a cellular network, a local bus, a point to point link (e.g., wired), and/or combinations of the aforementioned.

Computing environment 104 may include a network interface 116 for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Computing device 104 (and/or other components such as client terminals 108, 120) includes and/or is in communication with one or more physical user interfaces 150 that include a mechanism for a user to enter data (e.g., manually define the user achievement requirements) and/or view data (e.g., view the computed targets set of configuration parameters). Exemplary user interfaces 150 include, for example, one or more of, a touchscreen, a display, a virtual reality display (e.g., headset), gesture activation devices, a keyboard, a mouse, and voice activated software using speakers and microphone.

Referring now back to FIG. 2, at 202, a user achievement requirement is accessed, for example, manually entered by a user (e.g., via a user interface such as a graphical user interface), from a data storage device (e.g., local storage, remote storage), automatically computed, and the like.

The user achievement requirement indicates goals and/or milestones for a player to accomplish within a game run by the game engine. The user achievement requirement may enhance player engagement by providing additional challenges and goals beyond the main objectives of the game. For example, players may be motivated to explore more of the game world, try different strategies, or invest more time in the game to unlock achievements.

The user achievement requirement may be set regardless of which players will be playing the game. The user achievement requirement may be set for a group of players as a whole, without consideration of individual players. Alternatively, the user achievement requirement may be customized per player.

The user achievements may be for recognizing and/or rewarding players for completing tasks, reaching certain levels, mastering skills, and/or meeting other criteria set by the game developers.

The user achievement requirement may include one or more associated factors defining measurement of meeting the user achievement requirement by the player. The associated factors may indicate what is being measured for evaluation to determine whether or not the player met the user achievement requirement or not. The associated factors may be used for tracking progress and/or accomplishments of the players during the game, to determine whether the user achievement requirement is reached.

Optionally, the user achievement requirement includes a progression rate requirement defining a rate at which the player needs to advance through the game to achieve a target objective. The progression rate requirement may be selected to maintain a sense of pacing, challenge, and engagement within the gaming experience. Progression rate requirements can be tied to the advancement of the game's storyline, completion of specific missions or quests, or reaching certain levels or stages. This may help ensures that players are making meaningful progress and are appropriately challenged as they move through the game. The progression rate requirement may involve reaching a certain level within a specified timeframe or accumulating a set amount of experience points to unlock new abilities, items, or areas. There may be time-based progression rate requirements, for encouraging players to accomplish tasks within a specific time frame. This could involve completing missions within a time limit, achieving specific objectives before a deadline, or meeting certain milestones during timed events. Progression rate requirements may be linked to the accumulation of in-game resources, such as virtual currency, items, or equipment. Players may need to gather a certain amount of resources to unlock new content or enhance their characters. The associated factors may include an indication of the progression rate that player(s) are experiencing while trying to go through a certain level of the game executed by the gaming engine.

The progression rate requirement and associated factors may include, for example:
A parameter describing a probability of the player passing the certain level on the first try. The parameter may be a range, and/or value, For example, 30%, or 50%, or 70%, or 50-70%, or 30-50% probability, or other values. The associated factor may be an indication of whether the player will pass the certain level on the first try or not.
An average time for the player to pass the certain level. The average time may be a range, a value, and/or may include a standard deviation. For example, about 5 minutes+/−1 minute, about 3-6 minutes, or other values. The associated factor may be the elapsed play time on the certain level user to determine whether the player will play during the average time or not.
The percentage of players that are unable to pass the certain level without a clue and/or another aid. The percentage may be a range and/or value. For example, 25-40%, or about 50%, or other values. The associated factor may be an indication of whether a certain player appears unlikely to pass the certain level without the clue and/or other aid.

Alternatively or additionally, the user achievement requirement includes a return-to-player requirement defining a gain that the player is predicted to receive while playing the game. The return-to-player requirement may be, for example, an amount of reward predicted to be given for a certain charge to the player playing the game (e.g., for each $1 the player pays to play, the player is predicted to receive 10 gold coins), an amount of reward for a certain amount of time (e.g., for each minute of play, the player is predicted to obtain 5 coins), and an amount of social gain per amount of playing (e.g., for each hour of play, the player is predicted to increase their ranking by 0.2).

The associated factors may define measurement of meeting the return-to-player requirement.

The return-to-player requirement and associated factors may include, for example:
A parameter describing a financial gain of the player resulting from playing in conjunction with the gaming engine and as expressed using an in-game token and/or expressed using another class of assets associated with the gaming engine. For example, a player is predicted to gain an average of 150 gold coins playing the game. The associated factors may include the actual current financial gain of the player at a current point in time.
A parameter describing a social gain of the player resulting from playing in conjunction with the gaming engine. The social gain may relate to an increase of how other people perceive the player and/or resulting from the players sharing their accomplishments with others. Examples of social gain include number of interactions with other players, and/or being rated by other players. The associated factors may include the actual current social gain of the player at a current point in time. The social gain may indicate a level of competition, collaboration, or friendly rivalry among players.

The game may be a multi-player game which may be played by users using multiple client terminals communicating over a network with a server and/or computing cloud hosing the game engine over a network, a single player game played by a user on their own device (e.g., mobile device, client terminal) running the game engine, a single player game hosted by the game engine on the server and/or cloud where a user uses their client terminal to access the game engine over a network, and the like.

At 204, a target set of configuration parameters is computed. The target set of configuration parameters is predicted to result in the player meeting the user achievement requirement as measured by the associated factors when the target set of configuration parameters is used for configuring the gaming engine.

The target set of configuration parameters include a combination of a first type of configuration parameters and a second type of configuration parameters.

The first type of configuration parameters is associated with setting an effort level predicted to be tolerated by the player. The effort level predicted to be tolerated by the player may refer to the amount of time, energy, and/or difficulty a player is willing to invest or endure during a game. When the effort level is too high, the player cannot tolerate the required effort, and may terminate the game and/or not play in the first place. Different players may have varying preferences when it comes to the level of challenge, complexity, and time commitment they are willing to dedicate to a game. The effort level appropriate for a game may be selected according to a target audience and/or player demographics. Some players enjoy highly challenging and complex games that demand a significant investment of time and skill, while others prefer more casual and accessible experiences that are easy to pick up and play. In another example, for the same game, children may need a lower effort level than teenagers or adults.

Optionally, the first type of configuration parameter associated with setting the effort level predicted to be tolerated by the player includes an indication of increasing a difficulty of going through a certain level. Some players may enjoy a steep learning curve and challenging gameplay, while other players may prefer a more relaxed and forgiving experience. Moreover, different players may have varying amounts of time available for gaming. Some players may prefer short gaming sessions, while other player are willing to invest hours in a single play session. Furthermore, the depth and complexity of game mechanics, systems, and narratives can vary. Some players may enjoy intricate and deep gameplay, while other players may prefer simpler, more straightforward experiences. The tolerance for repetitive tasks or gameplay loops may vary among players. Some players may enjoy the grind in a game, while other players may find it tedious.

Examples of the first type of configuration parameter include:
A parameter indicating a number of negative events and/or sprites encountered by players trying to pass the certain level. The negative events and/or sprites may be of selected types which require varying effort levels to pass. For example, a negative event may be a block which may be overcome with simple effort by the player controlling a character to jump over the block. In another example, the negative event may be a monster character which fights with the character controlled by the player, requiring more effort by the player to defeat the monster.
A parameter indicating a level of availability of different aids to players trying to pass the certain level. The different aids may be of varying aid levels. For example, the player may obtain a magic potion which paralyzes monsters, enabling little effort to user to overcome the monster. In another example, the player may obtain a sword which requires more effort by the player to fight and defeat the monster.
A parameter describing graphical settings and/or user interface settings expected to influence player performance while trying to pass the certain level. For example, a field of view (FOV) may determine how much of the game world is visible on the screen at any given time. A narrow FOV showing less of the game world may require higher effort to play the game than a wide FOV showing more of the game world. In another example, pop-up boxes and/or messages indicating hints to the player of what to do, where treasures are found, and/or warning of obstacles, may reduce the effort level, while lack of such pop-ups and/or messages may increase the effort level.

The second type of configuration parameters is associated with setting a reward level predicted as an incentive by the player. The reward type, magnitude, and/or frequency of rewards that players receive within a game as incentives for their actions or achievements may be set. The reward may be, for example, obtaining in-game items, virtual currency, cosmetic items (e.g., skins costumes), access to new levels or areas of the game, extended play time, experience points, unlockable content, social rewards (e.g., publication of the name and/or picture of the player, ranking of the player relative to other players), real financial rewards, and/or real world prizes. The magnitude or value of rewards can vary. Some rewards may be small and frequent, while others may be more significant but less common. The reward level may provide additional motivation for players to pursue the goals and/or milestones of the game for reaching the user achievement requirement, by adding another a layer of satisfaction through tangible rewards. Players may be often motivated by a regular and balanced distribution of rewards. For example, too many rewards might lead to a lack of challenge, while too few could result in frustration. The reward may be implemented as a progression system where players unlock new abilities, items, or content as they advance. Achievements can be tied to specific rewards.

The target set of configuration parameters may satisfy a target balance between the first type and the second type of configuration parameters. The target balance may represent a combination of an intermediate range of values for the first type and second type of configuration parameters that are predicted to reach the user achievement requirement. For example, not too high and not too low. The target balance may be defined by a set of rules, for example, representing non-extreme values. The target balance may be represented as a non-extreme region within a function defined by different combinations of values of the first type and second type of configuration parameters. There may be multiple different combinations of ranges of the values of the first type and the second type that are predicted to result in the player achieving the user achievement requirement. However, extreme values of the first type and second type may be unsuitable even when they are predicted to result in the player achieving the user achievement requirement. For example, a high effort level required to play the game and a high reward obtained from playing the game may predict the player reaching the user achievement requirement. However, such combination is unsustainable, since players may be discouraged and/or become overly tired from playing, and stop playing altogether. The high reward may not be sufficient to keep them playing for long. Those players that do continue playing may reach the user achievement requirement. But there may be many players that quit playing the game altogether.

The combination of the first type and the second type of configuration parameters may be found, for example, by the following exemplary process. Identify ranges of values for the first type and the second type of configuration parameters that are desired, for example, non-extreme values and/or sustainable values, and/or other approaches described herein. Find a combination of maximal values for the first type and the second type of configuration parameters within the identified ranges that meet the user achievement requirement. The combination may be found, for example, by defining a function as a combination of the first type and the second type of configuration parameters over the identified ranges. Local minimums/maximums of the function may be found within the identified ranges that meet the user achievement requirement.

Exemplary approaches for computing the target set of configuration parameters that include the combination of the first type and second type are described, for example, with reference to FIG. 3 and FIG. 4.

Referring now back to FIG. 2, at 206, the target set of configuration parameters are provided. The target set of configuration parameters are predicted to result in the player meeting the user achievement requirement as measured by the plurality of associated factors, when the gaming engine is configured with the target set of configuration parameters.

At 208, the game engine configured with the target set of configuration parameters may be monitored while the player is playing the game. The monitoring may be performed to determine whether the player is meeting or likely to meet the user achievement requirement as measured by the associated factors.

At 210, a new record may be created. The new record may include the target set of configuration parameters used to configure the game engine and/or other parameters described herein. The new record may include a ground truth of the user achievement requirement of obtained by player as measured by the associated factors. The prediction engine may be trained and/or updated using the new record.

At 212, one or more features described with reference to 202-210 may be iterated.

Optionally, iterations are performed for dynamically adapting the target set of configuration parameters in response to the monitoring, for example, the balance of the first type and second type is improper (e.g., too extreme leading the player to discontinue play), and/or the player is not meeting the user achievement requirement as predicted.

Alternatively or additionally, iterations are performed for dynamically adapting the target set of configuration parameters for customizing the game engine for each player currently playing the game run by the game engine. For example, a different target set of configuration parameters is generated for each player. In another example, the target set of configuration parameters is dynamically adapted for each player during the playing of the game, optionally in response to the monitoring.

Alternatively or additionally, iterations are performed for generating multiple records for training and/or updating the prediction engine. For example, records may be for different players and/or at different points in the game, and/or for the game engine configured with different sets of configuration parameters.

Referring now back to FIG. 3, the features described with reference to FIG. 3 may be implemented with respect to the features described with reference to 204 of FIG. 2, as an exemplary approach for computing the target set of configuration parameters.

At 302, an effect of an initial set of candidate configuration parameters on the user achievement requirement is predicted. The effect is predicted for when the initial set of candidate configuration parameters is to be used for configuring the gaming engine.

The initial set of candidate configuration parameters may represent an initial estimate that is refined to obtain the target set of candidate configuration parameters. As such, the initial set of candidate configuration parameters may be obtained, for example, manually entered by a user, randomly generated values meeting a set of rules, from a previous configuration of the gaming engine, a trial and error approach, an outcome of a machine learning model trained to generate initial sets of candidate configuration parameters, and the like.

The effect may include one or more of: the value of the user achievement requirement, values of the associated factor(s) defining measurement of meeting the user achievement requirement, an indication of whether the user achievement requirement was met or not, and/or indication of how far the effect is from meeting or not meeting the user achievement requirement.

The prediction may be obtained as an outcome of a prediction engine. The prediction engine may be implemented as a ML model. The prediction engine may be trained to predict an effect of an input set of configuration parameters on the user achievement requirement. The prediction engine (e.g., ML model) may be trained on a training dataset of records. A record may include a sample set of a combination of configuration parameters, including the combination of first type of configuration parameters and the second type of configuration parameters. The record may include a ground truth indicating a sample effect of the sample set of combination of configuration parameters, including a combination of the first type and the second type, on the user achievement requirement.

Alternatively or additionally, the prediction engine may be implemented as a simulation engine for simulating implementation of an input set of configuration parameters on playing of the game for predicting the effect on the user achievement requirement. The simulation engine may simulate actions of real players playing the game on the game engine configured with the input set of configuration parameters. The simulation engine may be implemented using a ML model trained to mimic real player behavior, to obtain the simulated actions of real players. The ML model may be trained by learning historical interactions of real players with the game engine configured with one or more a sample sets of configuration parameters.

The predicted effect may be provided (e.g., sent) to a configuration engine and/or other entity.

The record used to train the prediction engine may include other sample parameters which may be used as input into the prediction engine during inference. The simulation engine may be fed the additional parameters. Examples of sample parameters include: demographic profile of the player (e.g., age, gender, income, education level, and the like), geographical location, experience level of the player, and a set preference of the player (e.g., whether the player likes challenging or easy games, short levels or hours long play).

At 304, the initial set of candidate configuration parameters is adjusted, by the configuration engine, based on the predicted effect, to generate a next set of candidate configuration parameters. The next set of candidate configuration parameters is generated according to a prediction that using the next set of candidate configuration parameters for configuring the gaming engine is predicted to result in increased likelihood of the player meeting the user achievement requirement in comparison to using the initial set of candidate configuration parameters to configure the gaming engine. For example, increase in probability of the player meeting the user achievement requirement using the next set relative to the initial set. In another example the next set is generated such that a statistical distance between the next set and the user achievement, is smaller than a statistical distance between the initial set and the user achievement.

The configuration engine may be implemented as an optimization process that finds the set of candidate configuration parameters that obtains an optimal predicted likelihood of the player meeting the user achievement requirement when playing a game on a gaming engine configured using the set of candidate configuration parameters. For example, using gradient descent approaches, and/or other numerical approaches.

Alternatively or additionally, the configuration engine may be implemented, for example, as a ML model trained to generate the next set of candidate configuration parameters in response to an input of the effect and the initial set of candidate configuration parameters. The ML model may be trained on a training dataset of records. A record may include a sample input of a sample effect and a sample initial set of candidate configuration parameters, and a ground truth of a sample next set of candidate configuration parameters selected such that using the sample next set for configuring the gaming engine is predicted to result in increased likelihood of the player meeting the user achievement requirement in comparison to using the sample initial set of candidate configuration parameters to configure the gaming engine.

At 306, the configuration engine provides the next set of candidate configuration parameters to the prediction engine, for generating another prediction of the effect of the next set of candidate configuration parameters on the user achievement requirement.

At 308, features described with reference to 302-306 may be iterated.

The iterating may be performed by setting the initial set of a subsequent iteration (i.e., in 302 of the subsequent iteration) according to the next set of the preceding iteration (i.e., from 306 of the preceding iteration).

The iterations may be terminated when the next set of candidate configuration parameters used for configuring the gaming engine results in the player meeting the user achievement requirement. Alternatively or additionally, the iterations may be terminated when subsequent sets of candidate configuration parameter are not predicted to significantly impact the player meeting the user achievement requirement, for example, a local minimum/maximum region is reached by the gradient descent process.

At 310, in response to the termination, the next set of candidate configuration parameters of the preceding iteration is provided as the target set of configuration parameters

Referring now back to FIG. 4, the features described with reference to FIG. 4 may be implemented with respect to the features described with reference to 204 of FIG. 2, as another exemplary approach for computing the target set of configuration parameters. In particular, for finding a better balance between the combination of the first type and second type of configuration parameters that is predicted to reach the user achievement requirement. The features described with reference to FIG. 4 may be implemented for computing an improved target balance between the first type and the second type of configuration parameters described with reference to 204 of FIG. 2. The improved target balance may be a more sustainable combination of the first type and second type in comparison to a previously determined target balance, for example, without extreme values. The improved target balance may increase likelihood of the player continuing to play and/or may increase likelihood of the ability of the game engine to sustain the game. The features described with reference to FIG. 4 may be used for evaluating whether the target set of configuration parameters predicted to reach the user achievement requirement computed as described with reference to 204 of FIG. 2 and/or FIG. 3 are non-extreme, such as sustainable by the gaming engine and/or are tolerable by player(s).

At 402, a set of candidate configuration parameters including a candidate balance between the first type of configuration parameters and the second type of configuration parameters, is determined. The candidate balance between the first type of configuration parameters and the second type of configuration parameter is predicted to meet the user achievement requirement when the gaming engine is configured according to the first balance.

The set of candidate configuration parameters may be generated, for example, using approaches described with reference to FIG. 3 for generating the target set of candidate configuration parameters predicted to meet the user achievement requirement. The target set of candidate configuration parameters computed as described with reference to 204 of FIG. 2 and/or FIG. 3 represent the set of candidate configuration parameters that are evaluated using features described with reference to FIG. 4.

At 404, the candidate set of configuration parameters are analyzed, for example, by a simulation engine and/or ML model. The simulation engine and/or ML model may simulate players playing the game run by the game engine configured with the set of candidate configuration parameters. The analysis may include the outcome of the simulation and/or outcome of the ML model.

At 406, impact of the candidate set of configuration parameters is determined according to the analysis to determine whether the candidate set of configuration parameters includes extreme values. For example, extreme values of the candidate set may be unsustainable and/or lead the player to stop playing.

Optionally, the second type of configuration parameters associated with setting the reward level predicted as an incentive by the player, may be determined according to the analysis to define a reward that is too high for the gaming engine to sustain. For example, a reward that is too high may result in in-game inflation and/or other detrimental effects. The detrimental effects may reduce enjoyment of the users playing the game, and/or may make playing the game less appealing for users.

Alternatively or additionally, the first type of configuration parameters associated with setting the effort level predicted to be tolerated by the player, may be determined according to the analysis to define an effort level that is too high for the players to tolerate. For example, players are unable to reach goals in the game, for example, complete a level and/or reach a stage in the game within a certain amount of time. The players may stop playing prematurely due to the high effort level, i.e., if the effort level was lower the players would continue to play.

At 408, in response to the impact, such as determining that the second type defines the reward that is too high and/or determining that the first type defines the effort level that is too high for players to tolerate, features described with reference to 402-406 may be iterated.

The iterations may be terminated when the impact meets the requirement.

Optionally, the iterations are terminated when the first type is determined according to the analysis to defined an effort level that the players tolerate. Alternatively or additionally, the second type may be determined according to the analysis to define the reward sustainable by the gaming engine.

At 410, the set of candidate configuration parameters, such as the most recent set of candidate configuration parameters obtained during the last iteration, is provided as the target set of configuration parameters.

The set of candidate configuration parameters provided as the target set of configuration parameters may represent the target balance between the first type and the second type of configuration parameters.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant game engines and machine learning models will be developed and the scope of the terms game engine and machine learning models are intended to include all such new technologies a priori.

As used herein the term “about” refers to +10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of automatically configuring a gaming engine to conform with a user achievement requirement for a player playing a game, comprising:
accessing, the user achievement requirement denoting goals and/or milestones for the player to accomplish within the game, the user requirement comprising a plurality of associated factors defining measurement of meeting the user achievement requirement by the player;
predicting a target set of configuration parameters that when used for configuring the gaming engine, result in the player meeting the user achievement requirement as measured by the associated factors,
wherein the target set of configuration parameters comprises a combination of a first type of configuration parameters and a second type of configuration parameters, the first type of configuration parameters being associated with setting an effort level predicted to be tolerated by the player, and the second type of configuration parameters associated with setting a reward level predicted as an incentive by the player; and
providing the target set of configuration parameters for configuring the gaming engine predicted to result in the player meeting the user achievement requirement as measured by the plurality of associated factors.

2. The method of claim 1, wherein the user achievement requirement includes a progression rate requirement defining a rate at which the player needs to advance through the game to achieve a target objective.

3. The method of claim 1, wherein the user achievement requirement includes a return-to-player requirement defining a gain that the player is predicted to receive while playing the game.

4. The method of claim 3, wherein the associated factors defining measurement of meeting the return-to-player requirement comprises at least one of: (i) a parameter describing a financial gain of the player resulting from playing in conjunction with the gaming engine and as expressed using an in-game token and/or expressed using another class of assets associated with the gaming engine, and (ii) a parameter describing a social gain of the player resulting from playing in conjunction with the gaming engine.

5. The method of claim 1, wherein the target set of configuration parameters comprises a target balance between the first type and the second type of configuration parameters.

6. The method of claim 5, further comprising:
determining, prior to the predicting of the target set of configuration parameters, a set of candidate configuration parameters comprising a candidate balance between the first type of configuration parameters and the second type of configuration parameters, wherein the candidate balance is predicted to meet the user achievement requirement;
analyzing the candidate set of configuration parameters by a simulation engine and/or a machine learning (ML) model;
determining according to the analysis that the second type of configuration parameters associated with setting the reward level predicted as an incentive by the player, defines a reward that is too high for the gaming engine to sustain;
in response to determining that the second type defines a reward that is too high, iterating the determining the candidate set, and the analyzing until the second type is determined according to the analysis to define the reward sustainable by the gaming engine; and
providing the set of candidate configuration parameters as the target set of configuration parameters comprising the target balance between the first type and the second type of configuration parameters.

7. The method of claim 5, further comprising:
determining, prior to the determining of the target set of configuration parameters, a set of candidate configuration parameters comprising a candidate balance between the first type of configuration parameters and the second type of configuration parameters, wherein the candidate balance is predicted to meet the user achievement requirement, and
analyzing the candidate set of configuration parameters by a simulation engine and/or outcome of a ML model;
determining according to the analysis that the first type of configuration parameters associated with setting the effort level predicted to be tolerated by the player, defines an effort level that is too high for the players to tolerate; and
in response to determining that the first type defines the effort level that is too high for the players to tolerate, iterating the determining the candidate set, and the analyzing until the first type is determined according to the analysis to define the effort level that the players tolerate; and
providing the set of candidate configuration parameters as the target set of configuration parameters comprising the target balance between the first type and the second type of configuration parameters.

8. The method of claim 1, wherein the predicting comprises:
predicting, by a prediction engine, an effect of an initial set of candidate configuration parameters on the user achievement requirement when the initial set of candidate configuration parameters is to be used for configuring the gaming engine, and sending the predicted effect to a configuration engine;
adjusting, based on the predicted effect, by the configuration engine, the initial set of candidate configuration parameters to generate a next set of candidate configuration parameters that when used for configuring the gaming engine, is predicted to result in increased likelihood of the player meeting the user achievement requirement in comparison to using the initial set of candidate configuration parameters to configure the gaming engine; and
providing, by the configuration engine to the prediction engine, the next set of candidate configuration parameters for generating another prediction of the effect of the next set of candidate configuration parameters on the user achievement requirement.

9. The method of claim 8, further comprising: in a plurality of iterations: implementing the predicting, the adjusting, and the providing, by setting the initial set of a subsequent iteration according to the next set of the preceding iteration, and terminating the iterations when the next set of candidate configuration parameters used for configuring the gaming engine results in the player meeting the user achievement requirement; and
candidate configuration parameters of the preceding iteration as the target set of configuration parameters.

10. The method of claim 8, wherein the prediction engine is includes a ML model trained to predict an effect of an input set of configuration parameters on the user achievement requirement, wherein the ML model is trained on a training dataset of a plurality of records, wherein a record includes a sample set of configuration parameters including the combination of the first type of configuration parameters and the second type of configuration parameters, and a ground truth indicating a sample effect of the sample set of configuration parameters including the combination of the first type of configuration parameters and the second type of configuration parameters on the user achievement requirement.

11. The method of claim 8, wherein the prediction engine includes a simulation engine for simulating implementation of an input set of configuration parameters on playing of the game for predicting the effect on the user achievement requirement.

12. The method of claim 11, wherein the simulation engine simulates actions of real players playing the game configured with the input set of configuration parameters.

13. The method of claim 12, wherein the simulated actions of real players is attained using a ML model trained to mimic real player behavior by learning historical interactions of real players with the game engine configured with one or more a sample sets of configuration parameters.

14. The method of claim 1, wherein at least one of the plurality of associated factors includes an indication of a progression rate that players are experiencing while trying to go through a certain level of the game executed by the gaming engine.

15. The method of claim 14, wherein the progression rate comprises at least one of: (i) a parameter describing a probability of the player passing the certain level on the first try, (ii) an average time for the player to pass the certain level, and (iii) the percentage of players that are unable to pass the certain level without a clue and/or another aid.

16. The method of claim 14, wherein at least one of the first type of configuration parameters of the target set of configuration parameters, associated with the effort level comprises an indication of increasing a difficulty of going through the certain level.

17. The method of claim 16, wherein the first type of configuration parameters associated with increasing the difficulty of going through the certain level, comprises at least one of: (i) a parameter indicating a number of negative events and/or sprites are encountered by players trying to pass the certain level, (ii) a parameter indicating a level of availability of different aids to players trying to pass the certain level, and (iii) a parameter describing graphical settings and/or user interface settings expected to influence player performance while trying to pass the certain level.

18. A system for automatically configuring a gaming engine to conform with a user achievement requirement for a player playing a game, comprising:
at least one processor executing a code for:
accessing, the user achievement requirement denoting goals and/or milestones for the player to accomplish within the game, the user requirement comprising a plurality of associated factors defining measurement of meeting the user achievement requirement by the player;
predicting a target set of configuration parameters that when used for configuring the gaming engine, result in the player meeting the user achievement requirement as measured by the associated factors,
wherein the target set of configuration parameters comprises a combination of a first type of configuration parameters and a second type of configuration parameters, the first type of configuration parameters being associated with setting an effort level predicted to be tolerated by the player, and the second type of configuration parameters associated with setting a reward level predicted as an incentive by the player; and
providing the target set of configuration parameters for configuring the gaming engine predicted to result in the player meeting the user achievement requirement as measured by the plurality of associated factors.

19. A non-transitory medium storing program instructions for automatically configuring a gaming engine to conform with a user achievement requirement for a player playing a game, which when executed by at least one processor, cause the at least one processor to:
access, the user achievement requirement denoting goals and/or milestones for the player to accomplish within the game, the user requirement comprising a plurality of associated factors defining measurement of meeting the user achievement requirement by the player;
predict a target set of configuration parameters that when used for configuring the gaming engine, result in the player meeting the user achievement requirement as measured by the associated factors,
wherein the target set of configuration parameters comprises a combination of a first type of configuration parameters and a second type of configuration parameters, the first type of configuration parameters being associated with setting an effort level predicted to be tolerated by the player, and the second type of configuration parameters associated with setting a reward level predicted as an incentive by the player; and
provide the target set of configuration parameters for configuring the gaming engine predicted to result in the player meeting the user achievement requirement as measured by the plurality of associated factors.
